(19) United States
(12) Patent Application Publication
(10) Pub. No.: US 2026/0073408 A1
(43) Pub. Date: Mar. 12, 2026

(54) Detection of Surfing Activity as Basis to Reduce Inconclusive Media-Exposure Characterization

(71) Applicant: The Nielsen Company (US), LLC, New York, NY (US)

(72) Inventors: Stanley Wellington Woodruff, III, Palm Harbor, FL (US); John Thomas LiVoti, Clearwater, FL (US); Daniel Nelson, Land O Lakes, FL (US)

(21) Appl. No.: 18/828,648

(22) Filed: Sep. 9, 2024

(51) Int. Cl. G06Q 30/0201; H04L 67/50

(52) U.S. Cl. CPC G06Q 30/0201; H04L 67/535

(57) ABSTRACT

A method and system for measuring media-surfing activity. An example method includes a computing system receiving reporting of packet-data activity at a panelist site. Further, the example method includes the computing system using at least the received reporting of packet-data activity at the panelist site as a basis to detect occurrence of media-surfing activity at the panelist site, where the media-surfing activity comprises a user surfing through one or more content-selection menus. Still further, the example method includes the computing system reporting the detected occurrence of media-surfing activity at the panelist site as media-exposure data. In further implementations, the method additionally includes the computing system using signature matching as a further basis to detect the occurrence of media-surfing, such as by detecting through the signature matching the presentation of streaming media content for a threshold short duration suggestive of a program preview when a user is engaged in media-surfing.

### SUMMARY

In order to measure the extent to which people of various demographics are exposed to media content presented (e.g., played out or output for presentation) by media-presentation devices such as televisions, computers, tablets, phones, gaming devices, smart speakers, radios, streaming-media players, set top boxes, audio-visual receivers, and combinations of these or other devices, for instance, an audience-measurement company can arrange to have media-monitoring devices or “presentation meters” monitor media presentation in representative households or other sites. People who have their media exposure monitored may be considered “panelists,” and the places where the monitoring occurs, such as home, offices, or other premises, may be considered “panelist sites.”

At each of various panelist sites having a media-presentation device for instance, the audience-measurement company may arrange for a presentation meter to monitor media presentation by that device and to generate query signature data representing the presented media. Further, the audience-measurement company may also operate a computing system, such as a cloud-based computing system, to receive and evaluate this presentation-meter-generated query signature data, in order to identify the media presented at the panelist site and thereby to establish associated media-exposure data.

For instance, by evaluating an audio line feed into the media-presentation device and/or by evaluating associated acoustic speaker output, a representative presentation meter at a panelist site may be configured to detect and extract watermarked identification codes from the audio and/or to generate digital audio fingerprint data representing the audio, and to report the identification codes and/or fingerprint data, along with associated timestamps, as query signature data to the computing system for analysis. Such a presentation meter may also be configured to detect the power on or off state of the media-presentation device, so that the presentation meter can limit its media-presentation monitoring to times when the media-presentation device is on and therefore likely presenting media content being delivered to the media-presentation device.

The computing system may then be configured to refer to reference signature data that maps various identification codes and/or fingerprint data to known media content items, in order to determine, based on the presentation-meter-reported identification codes and/or fingerprint data, what media content the media-presentation device was presenting at the indicated time. In particular, the computing system may be configured to search through the reference signature data in an effort to find reference signature data that matches the reported query signature data and, upon finding a match with sufficient certainty, to conclude that media represented by the query signature data is the media associated with the matching reference signature data, and to establish associated media-presentation records for the panelist site.

Further, the computing system may be configured to correlate these media-presentation records with pre-stored demographics of the panelist or panelist site at issue, in order to establish associated media-exposure data, and the computing system may be configured to use this media-exposure data from multiple panelist sites as a basis to establish ratings statistics that may facilitate commercial processes such as ad placement and other content delivery.

In an example implementation, to facilitate this process, the computing system could maintain or otherwise have access to a set of reference signature data specifically for identifying linear broadcast content feeds such as television-channel broadcasts, for instance, and possibly for identifying specific programs broadcast on such channels. This reference signature data, which may be referred to as Linear Media Monitoring Service (LMMS) reference signature data, could be established by implementing monitoring receivers tuned to known channels and configured to extract from the known channels watermarked codes as reference codes keyed to those known channels or their associated content, and/or to generate digital fingerprint data as reference fingerprint data representing and thus keyed to the media content on those known channels, among other possibilities. By matching the presentation-meter-provided query signature data against this LMMS reference signature data, the computing system may thus identify linear broadcast channels and possibly associated content presented at the panelist site.

In addition, the computing system may also maintain or otherwise have access to a separate set of reference signature data for non-linear streaming-media content (e.g., movies, television shows, podcasts, etc.) that panelists could watch, listen to, or otherwise consume on demand, e.g., from over-the-top (OTT) streaming-media providers or the like. This reference signature data, which may be referred to as Streaming Media Monitoring Service (SMMS) reference signature data, could be established by evaluating known streaming-media content items, possibly from particular OTT channels, extracting from the known streaming-media content items watermarked codes as reference codes keyed to those known streaming-media content items and/or generating digital fingerprint data as reference fingerprint data representing and thus keyed to the known streaming-media content items, among other possibilities. By matching the presentation-meter-provided query signature data against this SMMS reference signature data, the computing system may thus also identify non-linear media content, such as streaming-media content, presented at the panelist site.

In practice, the computing system may conduct this matching process with respect to query signature data that the computing receives from the presentation meter over time or that otherwise represents media content presented at the panelist site over time. That way, the computing system could establish records that indicate, per unit time, what media content was presented at the panelist site. For instance, the computing system may establish these records on a per minute basis or even a per-sub-minute basis, among other possibilities. Further, the computing system may conduct this analysis in real-time (e.g., as the computing system receives the query signature data from the panelist site, possibly soon after the associated media presentation occurred) and/or through post-processing (e.g., at the end of each day), among other possibilities.

As to each of various time segments of this presentation-meter-provided query signature data representing a corresponding time segment of media presentation at the panelist site, the computing system may further conduct its analysis as a multi-step process that helps make the computing system's use of the reference signature data relatively efficient. In particular, this multi-step process may help to control when the computing system will try to match the query signature data against the SMMS reference signature data.

In an example of this two-step process, as to each time segment of presentation-meter-provided query signature data, the computing system may initially restrict its matching analysis to just the LMMS reference signature data, in an effort to identify the presented media content as particular known linear broadcast content. The computing system may then turn to conduct matching with respect to the SMMS reference signature data just if and when the computing system finds no match with respect to the LMMS reference signature data.

In particular, for each time segment of presentation-meter-provided query signature data, the computing system may first search the LMMS reference signature data in an effort to find a match. Based on this search of the LMMS reference signature data, if the computing system thereby finds with sufficient certainty that the query signature data for that time segment matches LMMS reference signature data representing known linear broadcast content, then the computing system may responsively establish a record indicating that, at that time, that the panelist site was presenting that known linear broadcast content. Whereas, if the computing system does not find with sufficient certainty that the query signature data for that time segment matches any LMMS reference signature data, then, based at least on this absence of matching with the LMMS reference signature data, the computing system may responsively proceed to search the SMMS reference signature data in an effort to find a match.

If the computing system thus proceeds to search the SMMS reference signature data for a match, and if the computing system thereby finds with sufficient certainty that the query signature data for the time segment matches SMMS reference signature data representing known streaming-media content, then the computing system may responsively establish a record indicating that, at that time, that the panelist site was presenting that known streaming-media content. Whereas, if the computing system thereby does not find with sufficient certainty that the query signature data for that time segment matches any SMMS reference signature data, then, based at least on that absence of matching with the SMMS reference signature data, along with the absence of matching with the LMMS reference signature data, the computing system may establish an “inconclusive” record for that time segment (e.g., a record specifying an inconclusive result such as “All Other Tuning” (AOT) or “All Other Code” (AOC)), meaning that the computing system did not identify the media content that was being presented by the panelist site at that time.

To help manage this process further, the computing system may also take into consideration whether and when the panelist site was receiving a packet-data flow having a pattern or form that is deemed to be consistent with streaming media, i.e. having a “pattern of streaming.” For instance, when the computing system determines that presentation-meter-reported query signature data for a given time at the panelist site does not match any LMMS reference signature data, the computing system may further determine whether, at that time, the panelist site (e.g., the media-presentation device or an associated device at the panelist site) was receiving a packet-data flow that has a pattern of streaming, and the computing system may use this further determination as a basis to control whether the computing system will proceed to search the SMMS reference signature data for a match.

For instance, if the computing system thereby determines that, at that time, the panelist site was not receiving a packet-data flow that had a pattern of streaming, then the computing system may forgo searching for a match of the query signature data in the SMMS reference signature data, since a reasonable conclusion in that situation may be that the panelist site was not receiving and presenting streaming media at that time. In that case, since the computing system did not find a match of the query signature data in the LMMS reference signature data and since the computing system concluded that the panelist site was not presenting streaming media at the time, the computing system may record an “inconclusive” result as noted above. Whereas, if the computing system thereby determines that, at that time, the panelist site was receiving a packet-data flow that had a pattern of streaming, then the computing system may proceed to search the SMMS reference signature data for a match, in an effort to identify streaming media content that was being presented at the panelist site at the time.

To facilitate this consideration of the packet-data flow at the panelist site as a basis to control the computing system's use of the SMMS reference signature data, the audience-measurement company may additionally equip the panelist site with another type of meter, namely, a “streaming meter,” that is configured to monitor packet-data flow on a local area network (LAN) at the panelist site and to report to the computing system information about that packet-data flow. This streaming meter could be integrated with the presentation meter or another device or could be provided as a standalone device. And the streaming meter could be configured and interconnected as a logical intermediary between a router on the LAN and hosts (e.g., media-presentation devices) on the LAN so that the streaming meter would have a view of packet-data traffic flowing to and from each host.

In some implementations, for instance, the streaming meter could be set as a default gateway for each media-presentation device that may engage in packet-data communication on the LAN (e.g., each streaming-media player or other such device) (i.e., the devices could be set with a network address of the streaming meter as their default-gateway address), so that packet-data communications to and from those devices would flow through the streaming meter to give the streaming meter a view of that traffic. Further, the streaming meter could be configured to forward outbound packet traffic in turn to the LAN router and could accordingly also receive from the router inbound packet traffic that is destined to the media-presentation devices.

Such a streaming meter may implement safeguards to protect user privacy. To begin with, a panelist may opt in to have the streaming meter operate at the panelist site. Further, the streaming meter may be configured to process just metadata (e.g., packet headers, Domain Name Service (DNS) queries, etc.) rather than tracking content consumption or the like. Still further, the streaming meter may encrypt data both for transmission and storage, and the streaming meter may scramble private data.

The streaming meter may be configured to detect and report to the computing system various predefined packet-data-traffic events on the LAN, such as (i) when the LAN is receiving a packet-data flow that has a high enough bit rate and/or one or more other characteristics deemed to be a pattern of streaming, and (ii) when transitions occur between the LAN receiving a packet-data flow deemed to have a pattern of streaming and the LAN receiving no packet-data flow or receiving packet-data flow that has a low bit rate and/or one or more other characteristics deemed to not be a pattern of streaming. Further, these events can be on a per media-presentation-device basis, such as specifically for packet-data communications with a given streaming-media player or the like.

Based on these reports from the streaming meter at the panelist site, the computing system may thus be able to determine times when the panelist site was receiving a packet-data flow that had a pattern of streaming and times when the panelist site was receiving no packet-data flow or was receiving a packet-data flow that did not have a pattern of streaming. The computing system may then use this information as a basis to control whether, for time segments as to which the computing system finds that the presentation-meter-reported query signature data does not match the LMMS reference signature data, the computing system will turn to search for a match with the SMMS reference signature data, as noted above.

Further, for time segments as to which the computing system finds that there was a pattern of streaming and therefore turns to search for a match with the SMMS reference signature data, the computing system may also work to determine which streaming media service provider (streaming-media provider) (e.g., which streaming media channel) is the source of that streaming, as additional information to enhance ratings data. For this purpose, for instance, the streaming meter may also monitor DNS queries and/or packet-headers to determine a network domain with which a media-presentation device is communicating and may report that network domain information to the computing system.

To facilitate monitoring DNS queries, the streaming meter could also be set as a default DNS server for media-presentation devices on the LAN (i.e., the devices could be set with a network address of the streaming meter as their default DNS-server address), so that DNS queries from those devices could go to the streaming meter to give the streaming meter a view of those queries, and the streaming meter could be configured to forward those queries in turn to one or more actual DNS servers for actual processing.

Unfortunately, as panelists increasingly use streaming media services, one technical issue that may arise in practice is that there may be an increase in inconclusive (e.g., “AOT”) categorizations as noted above. For instance, there may be an increase in the number of time segments as to which metering establishes that a media-presentation device was powered on but as to which there is both no match with LMMS reference signature data and no detected pattern of streaming.

One reason for this increase in inconclusive categorizations is that users may increasingly engage in “surfing” in streaming media services, for instance where the users browse through menus of content available to be streamed. At times when a user surfs in a streaming media service, a media-presentation device (e.g., a streaming-media player with a television) may receive packet data to be rendered as graphical user interface (GUI) menus and menu items to present to the user. But the inflow of that packet data to the panelist site (e.g., to the media-presentation device) may not rise to the level of a pattern of streaming. Further, the content of those menus may be dynamically established, and there may be no associated LMMS reference signature data.

In particular, the streaming meter and/or computing system's baseline analysis to determine if packet-data flow has a “pattern of streaming,” e.g., as a basis to justify searching for a match in the SMMS reference signature data, may be keyed to one or more characteristics of streaming program content such as high definition television shows and movies for instance. That is, the “pattern of streaming” that the computing system may look for as a basis to trigger searching for a match in the SMMS reference signature data may be a pattern of program-content streaming. But in addition to receiving and presenting streaming program content such as television shows and movies, the panelist site may also receive and present content-selection GUIs as a user surfs for content to be streamed, and the packet-data traffic carrying that GUI content may not have a high enough or continuous enough bit rate and/or one or more other characteristics typical of streaming program content, so the streaming meter and/or computing system may therefore not find that traffic to have a pattern of streaming as a basis for searching for a match in the SMMS reference signature data.

For example, the streaming meter and/or computing system may be set to monitor data flow (e.g., on a per-domain basis, such as on a per source-IP-address basis) in short periods (e.g., 3, 5, 10, or 12 second periods) and to detect the presence of a pattern of streaming at times when (i) there is at least a predefined threshold number (e.g., 5, 6, 7, or 8) such periods of data contiguously from the same domain as each other, (ii) at least one of the threshold number of periods has at least a threshold high peak data rate (e.g., 30 kilobytes per second, 50 kilobytes per second, 100 kilobytes per second, or 1,000 kilobytes per second), and (iii) the minimum average data rate over the course of the detected periods is at least a predefined threshold high data rate (e.g., at least 10 kilobytes per second, at least 30 kilobytes per second, at least 100 kilobytes per second, or at least 1,000 kilobytes per second). This or other example processes may thus involve detecting a data flow with a bit rate that may be considered high enough to be typical of streaming of program content such as movies and television shows from OTT providers or the like. Therefore, as to query signature data representing media presented at the panelist site at times when the streaming meter was detecting such a pattern of packet-data flow, the computing system may reasonably turn to search the SMMS reference signature data in an effort to find a match.

However, at times when a user at the panelist site is surfing through a menu or menus available content of a given streaming-media provider (e.g., of a particular streaming-media channel), the menu content through which the user surfs may flow to the panelist site at a lower bit rate than is typical of streaming program content. Further, the menu content may not even flow as a continuous bit stream like some normal streaming of program content but may rather flow more sporadically in segments as the user surfs and may also include certain control messaging having a pattern that differs from streaming-media traffic.

Moreover, to the extent a streaming-media provider provides program-content previews as snippets of program content in connection with its content-selection menus, those previews may be short segments that may be more typical of surfing than of actual program streaming. Further, those preview segments may occur interstitially between times when there are no patterns of streaming, or, as the user surfs, may change from program to program over time in a manner that would also be typical of surfing rather than program streaming.

With the process described above, given query signature data representing a time segment of such surfing activity at the panelist site, the computing system may find that the query signature data does not match the LMMS reference signature data and may also find, based on reporting from the streaming meter, that, for at least some of that time, the panelist site was not receiving a packet-data flow having a pattern of streaming. Therefore, as discussed above, the computing system may unfortunately record an inconclusive result for that time segment.

The present disclosure provides an improved technical mechanism that may help to improve audience-exposure monitoring, by detecting the occurrence of surfing activity at a panelist site and making a record of that detected surfing activity as a basis for establishing ratings data. In particular, this mechanism may facilitate establishing how much time users tend to spend surfing, possibly on a per streaming-media-provider basis, which may inform commercially useful decisions and processes.

In accordance with the disclosure, the computing system may detect the occurrence of surfing activity at a panelist site, based at least on the computing system detecting that a pattern of packet-data traffic and/or content presentation at the panelist site is consistent with surfing activity in particular. Further, the computing may specifically detect the occurrence of surfing activity as to a given streaming-media provider (e.g., surfing through a content-selection menu or menus of the given streaming-media provider, such as for a given streaming-media channel), based at least on the computing system detecting that a pattern of packet-data traffic and/or content presentation at the panelist site is consistent with surfing activity as to that streaming-media provider (e.g., streaming-media channel) in particular. The computing system may then make a record of that detected surfing activity as a basis for establishing ratings data, among other possibilities.

To facilitate this, the computing system may refer to pre-established surfing-profile data that indicates characteristics of surfing activity perhaps specifically on a per-streaming-media-provider basis. For instance, this surfing-profile data may indicate per streaming-media provider a typical pattern of packet-data traffic possibly related to the panelist site obtaining content-selection menu elements and possibly program-preview content for presentation, with this pattern differing from streaming-media provider to streaming-media provider. Further, this surfing-profile data may indicate per streaming-media provider a typical pattern of presentation of program-preview content snippets during surfing, such as durations, intervals, or the like, also with this pattern differing from streaming-media provider to streaming-media provider.

Based on streaming-meter event reports and signature matching as to the panelist site, the computing system may thus determine based on this surfing-profile data that there was surfing activity at the panelist site, and possibly that the surfing activity was surfing as to a given streaming-media provider. For a given time segment of analysis, the computing system may then record the fact of that detected surfing activity as useful media-exposure data rather than recording an inconclusive result.

These as well as other aspects, advantages, and alternatives, will become apparent to those of ordinary skill in the art by reading the following detailed description, with reference where appropriate to the accompanying drawings. Further, it should be understood that the disclosure provided in this summary elsewhere in this document is provided by way of example only and that numerous variations and other examples may be possible as well.

### BRIEF DESCRIPTION OF THE DRAWINGS

FIG. 1 is a simplified block diagram illustrating an example system in which disclosed features can be implemented.

FIG. 2 is a flow chart illustrating an example method.

FIG. 3 is a simplified block diagram of an example computing system.

FIG. 4 is a simplified block diagram of an example presentation meter.

FIG. 5 is a simplified block diagram of an example streaming meter,

### DETAILED DESCRIPTION

It should be understood that this and other arrangements and processes described herein could take various other forms. For instance, elements and operations could be reordered, distributed, replicated, rearranged, combined, omitted, added, or otherwise modified. In addition, elements described as functional entities could be implemented as discrete or distributed components or in conjunction with other components/modules, and in any suitable combination and location. Further, various operations described as being carried out by one or more entities could be implemented by and/or on behalf of those entities, through hardware, firmware, and/or software, such as by one or more processing units executing program instructions stored in memory, among other possibilities.

### Example Network Arrangement

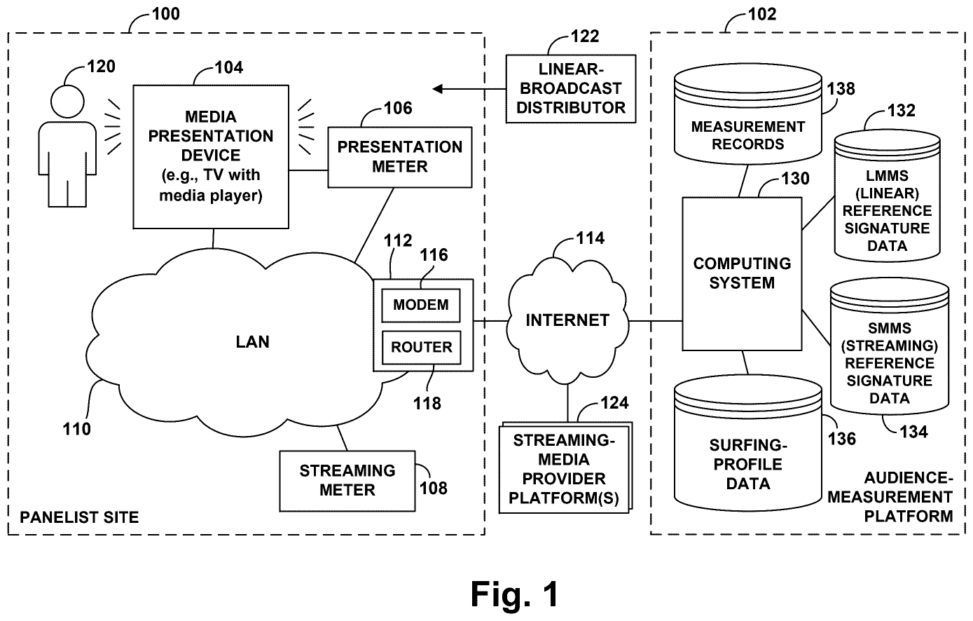

Referring to the drawings, as noted above, FIG. 1 is a simplified block diagram of an example system in which various disclosure features can be implemented. As shown in FIG. 1, the example system includes a panelist site 100 and an audience-measurement platform 102.

The panelist site 100 may be a panelist's home or office, among other possibilities and, in the example arrangement, includes a media-presentation device 104, a presentation meter 106, and a streaming meter 108. Further, the panelist site 100 includes a LAN 110, with the media-presentation device 104, presentation meter 106, and streaming meter 108 sitting as example nodes on the LAN 110. In addition, the panelist site 100 includes network equipment 112 that facilitates communication on the LAN 110 and communication between the LAN 110 and the internet 114 or another wide area network.

As shown, the network equipment 112 in the example arrangement may include a modem 116 and a router 118. The modem 116, which may be a cable, satellite, cellular, or other modem, may be configured to communicate with an associated internet service provider (ISP) (e.g., cable or satellite head end, or cellular core network) (not shown) that provides connectivity with the internet 114. And the router 118, which may itself also sit as a node on the LAN 110, may be configured to route packet-based communications between nodes on the LAN 110 and, via the modem, between the LAN 110 and the internet 114.

The modem 116 may have an assigned Internet Protocol (IP) address that is globally-routable on the internet 114 (i.e., a global IP address). For instance, when the modem 116 is initially powered on, the modem 116 may register its presence with the ISP, and the ISP may dynamically assign a global IP address to the modem 116, or the modem 116 may have a statically assigned global IP address. This global IP address assigned to the modem 116 may also pass through to the router 118 as an effective global IP address of the router 118.

Each LAN node may also have an assigned IP address that is locally-routable on the LAN 110 (i.e., a local IP address). For instance, the router 118 may have a statically assigned local IP address. Further, as each other node is initially powered on and in communication with the router 118, the node may register its presence with the router 118, and the router 118 may dynamically assign a local IP address to the node, or the node may a statically assigned local IP address. With these assigned local IP addresses, the LAN nodes may then engage in packet-based communication on the LAN 110. Further, the LAN nodes may engage in packet-based communications on the internet 114, through the router 118 and the modem 116, with the router 118 performing network address translation between the device's local IP address and the router/modem's global IP address.

In addition, each LAN node may have a permanent or semi-permanent hardware address, typically a Media Access Control (MAC) address assigned to a network interface of the node during manufacturing. This MAC address may uniquely identify the node. For instance, a node's MAC address may include a prefix or one or more other components keyed to the node's manufacturer and thus possibly indicating a brand of the node, and a node's MAC address might also include one more components corresponding with the node's model or other such information.

The media-presentation device 104 at the panelist site 100 may take any of the forms noted above among other possibilities, and may be configured to present media content, which may include video content and audio content and may include program content (e.g., television programs, videos, podcasts, radio shows, and movies), as well as content-selection menus and the like through which a user may surf. The media-presentation device 104 be a single unit or a multi-component system. For instance, the media-presentation device 104 may include a television (TV) with a streaming-media player (e.g., OTT receiver/player), whether that streaming-media player is integrated with the TV or interconnected with the TV. Further, the media-presentation device may include separate components for outputting video and audio, such as a TV for presenting video and an interconnected receiver and sound speakers for presenting audio, among other possibilities. As further shown, an example panelist (e.g., a human being) 120 at the panelist site 100 may be exposed to this media presentation.

The media-presentation device 104 may be configured to receive and present media content from one or more media sources, examples of which include a linear-broadcast source and a streaming-media source, among other possibilities.

A linear-broadcast source may include a linear-broadcast distributor 122, such as a satellite TV head end, cable TV head end, a satellite radio head end, or an over-the-air (OTA) terrestrial broadcaster, among other possibilities. This linear-broadcast distributor 122 may be a multi-channel video or audio program distributor, providing multiple channels of linear broadcast content for selective playout at the panelist site 100. The panelist site 100 may then further be equipped with a set top box or other device (possibly part of the media-presentation device 104) configured to allow user selection of a given such linear-broadcast channel to be presented by the media-presentation device 104, to tune the selected channel, and to provide the channel as a linear broadcast feed for presentation by the media-presentation device 104, and the media-presentation device 104 may thus present that selected linear-broadcast channel.

A streaming-media source, on the other hand, may be a streaming-media-provider platform 124 that includes one or more streaming-media servers (e.g., OTT servers) operated by or for a streaming-media provider, possibly specific to a particular streaming-media channel (e.g., a particular streaming-media service), among other possibilities. The streaming-media-provider platform 124 may be configured to provide streaming media content on demand in a streaming media session to the panelist site 100. To facilitate this, the media-presentation device 104 may be configured to interwork with the streaming-media-provider platform 124. For instance, the streaming-media-provider platform 124 may be accessible at a particular IP address on the internet 114, and the media-presentation device 104 may engage in signaling with the streaming-media-provider platform 124 at that address to request the streaming media server to stream user-selected media content on demand to the media-presentation device 104. In real time as the streaming media server then responsively streams the selected media content to the media-presentation device 104, the media-presentation device 104 may receive that streaming media session and output the media content for presentation.

Without limitation, streaming sessions like this could operate according to any of a variety of well-known adaptive bit-rate streaming protocols, examples of which include Dynamic Adaptive Streaming over Hypertext Transfer Protocol (HTTP) (DASH), HTTP Live Streaming (HLS), and Smooth Streaming Transport Protocol (SSTP).

Under such a protocol, the media-presentation device 104 may first request and obtain from the streaming media server a manifest that lists media stream segments and bit-rate versions available per segment. The media-presentation device 104 may then proceed to request and obtain desired bit-rate versions of those segments in sequence, varying the bit rate over time as necessary to help account for changes in operational conditions. And as the media-presentation device 104 receives the segments, the media-presentation device 104 may buffer the segments and ultimately transcode them into a form suitable for output to and presentation, thus facilitating largely real-time presentation of the selected media stream as the media-presentation device 104 receives the media stream.

These communications by the media-presentation device 104 may all be packet-based. For instance, to obtain a manifest for the selected stream, the media-presentation device 104 may transmit to the streaming-media-provider platform 124 one or more IP packets carrying a request for the manifest and may receive in response from the streaming media server one or more IP packets carrying the requested manifest. Likewise, to obtain the sequential segments of the media stream for playout, the media-presentation device 104 may transmit to the streaming media server a number of IP packets carrying requests for the segments and may receive in response from the streaming media server packets that carry the requested segments.

Further, these packet-based communications may be keyed to the local IP address and/or MAC address of the media-presentation device 104, with network address translation (NAT) between that local IP address and the global IP address of the router/modem.

For instance, when the media-presentation device 104 sends a packet destined to the IP address of a streaming-media-provider platform 124, the media-presentation device 104 may designate in a header of that packet that the source IP address of the packet is the media-presentation device's local IP address, and that the destination IP address of the packet is the streaming-media-provider platform's global IP address. As that packet passes through the router 118, the router 118 may apply NAT, translating the designated local IP source address to the router's global IP address, and ensuring that there is a record or designation of a port or MAC address associated with the designated local IP source address so that the router 118 can properly route a response.

When the streaming-media server then sends a packet back in response, that response packet would designate that the source IP address of the packet is the streaming-media provider platform's global IP address and that the destination IP address of the packet is the router's global IP address. Therefore, the packet will be routed ultimately to the router 118. Based on the record or designation of the port or MAC address associated with the local IP address from which the request originated, the router 118 may then translate the designated global IP destination address to the media-presentation device's local IP address. And the router 118 may then route the packet accordingly over the LAN to that local IP address, to facilitate receipt by the media-presentation device 104.

### Example Content-Selection Menus and Surfing

As discussed above, a streaming-media provider may also provide content-selection menus through which a user such as panelist 120 could surf, in search of program content of interest to be streamed. In practice, the streaming-media-provider platform 124 of a given streaming-media provider may provide these content-selection menus for presentation by the media-presentation device 104 in a manner that enables the user to surf through the menus in search of content. The structure of these menus and the manner of delivering them for presentation to the user may differ from streaming-media provider to streaming-media provider.

The content-selection menus provided by a streaming-media provider to facilitate content surfing may be GUI-based, with a GUI presenting numerous thumbnail images representing available programs, and allowing a user to page and scroll through the thumbnails and to select a desired program to be streamed. For instance, such a GUI may define vertically and horizontally navigable groups of such thumbnails per genre or other classes, allowing a user to scroll through those groups and the thumbnails respectively in each group to view available content. And a user of the media-presentation device 104 may use a remote control or touch screen to navigate through one or more such menus.

A streaming-media provider may deliver content-selection menus to the media-presentation device 104 in various ways. Without limitation, for instance, the streaming-media provider could deliver content-selection menus to a media player component of the media-presentation device 104 by delivering to the media player a markup document or manifest file that specifies elements of the content-selection menus, and by having the media player progressively download and render those specified elements or groups of elements at a time as a user scrolls through the menus. Other streaming-media providers may deliver content-selection menus to the media-presentation device in other ways and with other timing.

To facilitate surfing through one or more content selection menus of a given streaming-media provider, the media-presentation device 104 may thus engage in packet-based network communication with the associated streaming-media-provider platform 124. This network communication may include the media-presentation device 104 transmitting request messages to the streaming-media-provider platform 124 and receiving response messages from the streaming-media-provider platform 124. These messages may use Hypertext Transfer Protocol (HTTP) and/or one or more other protocols.

By way of example, when a user of the media-presentation device 104 is interacting with a streaming-media provider's channel, the user may navigate to a content-selection mode of the channel by selecting a “search” option or the like. In response, the media-presentation device 104 may engage in packet-based communication with the streaming media provider to request and download a markup document or manifest specifying elements of one or more content-selection menus, and the media-presentation device 104 may engage in further packet-based communication with the streaming-media provider to request and download some of those elements and may render those elements. As the user then scrolls through such a menu, the media-presentation device 104 may then engage in further packet-based communication with the streaming-media provider to request and download more of the elements and may render those additional elements. Alternatively, some or all of this messaging may be with the streaming-media provider by being with one or more entities operating on behalf of the streaming-media provider.

Furthermore, some streaming-media providers may provide program-content previews as snippets of program content in connection with their content-selection menus. For instance, a section of the content-selection GUI may be reserved for presentation of such a preview when the user has navigated to the thumbnail of a given content item, or the thumbnail may change from a static image to a video preview of the content item. To facilitate this, a markup document or manifest provided by the streaming-media provider may specify a video link respectively per thumbnail, causing the media-presentation device 104 to engage in packet-based messaging to request and receive streaming of an associated video when the user navigates to a given thumbnail. Such video preview content may be hosted by the streaming-media provider or by one or more other entities as well.

The form of packet-based communication that flows to and from the media-presentation device 104 in relation to this surfing may be specific to the streaming-media provider and may thus differ from provider to provider. For instance, depending on factors such as what extent of content-selection menus the media-presentation device 104 downloads at a time and what entity or entities the media-presentation device 104 communicates with to facilitate the surfing, the packet-based communication may have provider-specific characteristics such as timing of packet-based messaging, size of packet-based messaging, and addressing of packet-based messaging.

By way of example, when a user surfs through one or more content-selection menus of a given streaming-media provider, the media-presentation device 104 may download large groups of menu elements at a time and may receive streaming of program-content previews each of a given duration and with a given bit rate, possibly receiving the program-content previews from a given streaming server. Whereas, when a user surfs through one or more content-selection menus of another streaming-media provider, the media-presentation device 104 may download much smaller groups of menu elements at a time and may not receive streaming of program-content previews or may receive streaming of program-content previews of a different duration and/or a different bit rate, and possibly from a different streaming server. Numerous other differences may exist as to the packet-based communication for surfing through available content of one streaming-media provider versus the packet-based communication for surfing through available content of another streaming-media provider.

### Metering, and Use of Meter-Reported Data

In the example arrangement of FIG. 1, as the user surfs through one or more content-selection menus of a given streaming-media provider and as the media-presentation device 104 thus presents the one or more content-selections menus of that streaming-media provider, the presentation meter 106 and streaming meter 108 may carry out their ongoing programmed operations, to log media presentation and streaming-media activity respectively and to report that logged data to an computing system 130 of the audience-measurement platform 102, for use in generating audience ratings or for other purposes. In particular, the presentation meter 106 may operate to monitor media presentation by the media-presentation device 104, and the streaming meter 108 may operate to monitor packet-data traffic on the LAN 110.

Though these meters are shown as separate devices, they could alternatively be integrated together as an integrated device that has a view into both media presentation and LAN activity. Further, either or both of these meters may be integrated with the media-presentation device 104, such as being integrated with a television for instance. Further, the meters could interoperate with each other, such as by sharing their logged data with each other and possibly having just one of the meters assume responsibility for reporting both meters' logged data, among other possibilities.

In line with the discussion above, the presentation meter 106 may be configured to monitor both the on/off state of the media-presentation device 104 and media presentation by the media-presentation device 104. To facilitate monitoring the on/off state of the television media-presentation device 104, the presentation meter 106 could be connected as an intermediary in a path of power-supply to the media-presentation device 104 if applicable. The presentation meter 106 could then monitor current flow and/or other electronic characteristics on that path, to determine when the media-presentation device 104 is powered on and when the media-presentation device 104 is powered off. The presentation meter 106 could then limit its monitoring of media presentation by the media-presentation device 104 to times when media-presentation device 104 is powered on.

Further, the presentation meter 106 could be configured to monitor media presentation by the media-presentation device in various ways. For instance, the presentation meter 106 could be connected as an intermediary in the media-delivery path within or to the media-presentation device 104. The presentation meter 106 could then monitor media flowing on that path. Alternatively, the presentation meter 106 could include one or more microphones and/or cameras configured to receive audio and/or video output presented by the media-presentation device 104 and/or associated systems and could monitor that received audio and/or video.

The presentation meter 106 may interwork with the computing system 130 of the audience-measurement platform 102 (one or more associated servers) to detect and evaluate media presentation by the media-presentation device 104 (and/or by an associated system), which may include identifying the media presented by the media-presentation device 104, to facilitate generating audience ratings statistics and/or for other purposes. By way of example, the presentation meter 106 may detect the presence of media output by the media-presentation device 104 and may obtain media-signature data such as digital fingerprints and/or watermark encoded information from the media and transmit the obtained media-signature data as query signature data to the computing system 130 for evaluation as discussed above.

As to digital fingerprints, for instance, as the media presentation proceeds, the presentation meter 106 may evaluate the media being presented and, based on the evaluation, may generate digital query fingerprints each representing component characteristics of the media, such as key audio-frequency characteristics and/or key video-pixel characteristics. Further, the presentation meter 106 may include with each query fingerprint a timestamp indicating time of presentation of the media (e.g., media frame) represented by that particular query fingerprint. The presentation meter 106 may then periodically send bundles of these generated query fingerprints as query signature data to the computing system 130 for analysis.

As to watermarking, on the other hand, the media content as presented by the media-presentation device 104 may be periodically or otherwise from time to time watermarked (e.g., steganographically encoded) with media-identifying information or with data that correlates with media-identifying information.

Audio, for instance, could be watermarked with such data by including a supplemental audio waveform (optimally outside of human hearing range) that carries a representation of the data. By way of example, if a codeword that identifies the media is a sequence of digits, each digit could be sequentially encoded into the audio by adding a unique tone combination having a predefined correlation with the digit. Further, synchronizing symbols could be encoded as respective tone combinations as well, to demarcate the presence of the watermark.

Using audio for example, as the media presentation proceeds, the presentation meter 106 may thus monitor the audio in search of such a watermark and, upon finding a watermark, may decode the watermark by evaluating the sequential tone combinations, as a basis to extract the media-identifying information. The presentation meter 106 may thus record this media-identifying information over time with timestamps indicating when the watermarked media was presented. And the presentation meter 106 may likewise periodically send bundles of this media-identifying information as query signature data to the computing system 130 for analysis.

In real-time or through post-processing as noted above, the computing system 130 may then compare this presentation-meter-reported query signature data with established reference signature data respectively representing known media content (e.g., known programs, advertisements, channels, etc.) For instance, the computing system 130 could compare the query signature data with LMMS reference-signature data 132 and with SMMS reference-signature data 134. And upon finding with sufficient certainty that the query signature data representing the media content presented at the panelist site 100 matches reference signature data representing specific known media content, the computing system 130 could conclude that the media presented at the panelist site 100 is that specific known media content.

The computing system 130 could then establish media-presentation records 138 as noted above, indicting the media presented at the panelist site 100. Further, the computing system 130 may correlate this record with associated panelist demographics and may use the resulting records as a basis to establish media-exposure data and audience ratings, and/or to facilitate one or more other operations.

In particular, whether through use of fingerprinting, watermarking, or other media-signature processes, the computing system 130 may thereby establish records indicating times when particular identified media content was presented at the panelist site 100 and correspondingly times when one or more panelists at the panelist site 100 were exposed to that media. Further, the computing system 130 may correlate this information with predetermined demographics regarding one or more panelists at the panelist site 100, to establish records of times when one or more panelists of the predetermined demographics were exposed to the identified media. The computing system 130 may further aggregate this type of information from multiple panelist sites as a basis to generate more comprehensive ratings statistics, which may help inform and control later placement of program or advertisement content and/or other actions.

Further in line with the discussion above, the streaming meter 108 may operate to monitor packet-data traffic on the LAN 110. For instance, the streaming meter 108 could be configured to monitor streaming-media activity on the LAN 110 by monitoring the LAN 110 to detect the occurrence of particular network events that relate to streaming-media sessions. Further, the streaming meter 108 may be configured to monitor for other types of packet-data-traffic events as well.

To facilitate this, the streaming meter 108 could be configured to operate as a router, a packet-sniffer, and/or another device that would have a view of packet traffic traversing the LAN 110. For instance, the streaming meter 108 may be set as the default gateway and default DNS server for client devices on the LAN, particularly any devices that may be engaged in packet-data communication related to media streaming and other events that may be of interest. Further, the streaming meter 108 may be integrated with the router 118 or may be an additional router on the LAN 110, or the streaming meter 108 may be a standalone packet-sniffer or the like.

When packets flow on the LAN 110, the streaming meter 108 may thus detect the flow of those packets. Further, the streaming meter 108 may read header data of the detected packets, to determine and record the source and destination IP addresses of the packets. And the streaming meter 108 may be able to read select payload data from the packets.

Based on this monitoring of the packets flowing on the LAN 110, the streaming meter 108 may be configured to detect the occurrence of particular network events related to streaming-media sessions and/or other activity and to report those detected network events to the computing system 130 along with associated timestamps indicating the times of occurrences of the network events. These network events could take various forms.

By way of example, the streaming meter 108 may monitor the bit rate of packet-data flow into the LAN 110, such as the bit rate of data flowing into the LAN from one or more IP addresses outside of the LAN 110, and the streaming meter 108 may record timestamps of when the streaming meter 108 detected certain bit rates of such packet-data flow into the LAN 110.

Further, the streaming meter 108 may filter this analysis to be with respect to packet-data communication with one or more streaming-media clients at the panelist site 100, such as for example with a media player component of the media-presentation device 104 for instance. Namely, the streaming meter 108 may consider header information in packets flowing on the LAN 110 as a basis to limit its analysis to packets to or from an IP address of such a streaming-media client, thus helping to focus on packet-data flow that may be more likely related to streaming-media communication.

Based at least on this monitoring of the bit rate of the packet-data flow, and the streaming meter 108 may detect and report when that packet-data flow into the LAN 110 has one or more characteristics that may be deemed a pattern of program streaming, such as a high enough bit rate over a long enough time that the flow is likely consistent with the typical flow of a streaming of program content. For instance, the streaming meter 108 may detect and report when the LAN 110 is receiving a packet-data flow that has a bit rate high enough and lasts long enough to meet the “pattern of streaming” criteria discussed above, and based at least on that analysis, the streaming meter 108 may conclude that that flow has a pattern of program-content streaming.

Further, based at least on this monitoring of the bit rate of the packet-data flow into the LAN, the streaming meter 108 may detect and report when there is non-zero packet-data flow into the LAN 110 that does not have the one or more characteristics that may be deemed to be a pattern of program-content streaming. For instance, the streaming meter 108 may detect and report when the LAN 110 is receiving a packet-data flow that the streaming meter finds to be of a low enough bit rate over time or to not last long enough, for example, thus not meeting the “pattern of streaming” criteria described above, and thus indicating that the flow is likely not consistent with the typical flow of a streaming program content. Further, the streaming meter 108 may detect and report when there is no streaming, even for a short time for instance.

Still further, the streaming meter 108 may detect and report when transitions occur between these or other types of packet-data flow. For instance, the streaming meter 108 may detect and report when packet-data flow into the LAN 110 transitions from having one or more characteristics that may be deemed to be a pattern of program-content streaming (e.g., having a high enough bit rate over time to be consistent with typical streaming of program content) to not having the one or more characteristics that may be deemed to be pattern of program-content streaming (e.g., to having a non-zero but low enough bit rate over time that is not consistent with streaming of program content). Further, the streaming meter 108 may detect and report when there is a transition between streaming data flow on the LAN 110 and no streaming data flow on the LAN 110

In addition, the streaming meter 108 may detect and report other associated information that may relate to transitions of packet-data flow into the LAN 110. For instance, the streaming meter 108 may detect and report when changes occur in the source IP address of packet data flowing into the LAN 110 and/or when changes occur in owner/digital rights management (DRM) metadata carried by packet-data flowing into the LAN 110, among other possibilities. Further, the streaming meter 108 may detect and report other network activity, such as a rate or other extent to which back-and-forth packet-data communications occur between the panelist site 100 and a given external IP address, among other possibilities.

For present purposes, the presentation meter 106 may generate and report to the computing system 130 query fingerprints representing the presented media, which may include audio fingerprints representing audio of presented program-content previews if any that may be presented while a user is surfing. Further, the streaming meter 108 may detect and report to the computing system 130 packet-data-traffic events, which may include events related to surfing, such as instances and timing of messaging and instances and timing of incoming high-bit-rate flow suggestive of streaming media.

### Use of Meter-Reported Data as Basis to Detect Surfing Activity

In line with the discussion above, the computing system 130 may then evaluate this reported information as a basis to detect that there was surfing activity at the panelist site 100, and the computing system 130 may accordingly record the fact of that surfing activity as useful media-measurement data, to facilitate generation of enhanced ratings statistics for instance. In particular, the computing system 130 may detect that there was a pattern of packet-data traffic at the panelist site 100 that is consistent with surfing activity and/or that there was a pattern of content presentation at the panelist site 100 that is consistent with surfing activity, and the computing system 130 may accordingly conclude that surfing activity occurred, possibly surfing activity specific to a given streaming-media provider.

Detecting that a pattern of packet-data traffic at the panelist site 100 is consistent with surfing activity in particular may involve detecting one or more properties of the packet-data traffic that are characteristic of surfing activity. Examples of such properties may include, without limitation, (i) particular rates or other timing patterns of control messaging to/from a media-presentation device such as a streaming-media player, possibly when such messaging is with a particular streaming-media provider or the like, and possibly when the messaging is characteristic of progressive downloading of content-selection menus or menu items (e.g., content thumbnails) or the like and (ii) particular sizes of such control messages to/from the media-presentation device, possibly in conjunction with the rates or other timing patterns.

In an example implementation, this detecting of surfing activity and recording of associated media-exposure data may follow a determination that the packet-data traffic does not have a pattern of streaming, e.g., that the incoming packet-data traffic did not have a high enough bit rate for a long enough period of time to represent likely program streaming.

For example, the computing system 130 may first find that query signature data for a particular time segment of media presentation at the panelist site 100 does not match the LMMS reference-signature data 132 and that, at that time, the panelist site 100 was receiving packet-data communication that did not have a pattern of program-content streaming. In response to those findings, the computing system 130 may then check to see if the panelist-site packet-data traffic in that time segment was consistent with surfing activity possibly as to a particular streaming-media provider, in an effort to detect that a user at the panelist site 100 was engaged in such surfing at that time. Further, upon detecting the occurrence of that surfing activity, the computing system 130 may then record data indicating the occurrence of that surfing activity, e.g., generally indicating that there was user surfing activity possibly as to a particular streaming-media provider.

Furthermore, to account for possible situations where a streaming-media provider streams program-content previews as snippets of program content in connection with its content-selection menus through which a user may surf, the computing system 130 may base its detection of surfing activity on detecting presentation at the panelist site 100 of one or more such short preview segments, possibly with a timing pattern that is suggestive of surfing.

For instance, in response to detecting the occurrence of high-bit-rate packet-data flow that does not rise to the level of a pattern of streaming (e.g., because it does not last long enough), the computing system 130 may nevertheless look for and find a query signature match with the SMMS reference-signature data 134, to find that the panelist site 100 was receiving and presenting streaming media content at that time. But the computing system 130 may further find, based on the query signature data and/or the streaming-meter reported data, that what the panelist site 100 was receiving and presenting at that time was actually just preview program content rather than a program itself.

By way of example, the computing system 130 may further find, from the query signature data and/or from the streaming-meter reported data, that the detected presentation of streaming media content was presentation of a particular program for just a short time duration, namely, for a duration that was short enough to suggest that it was a program-content preview as part of surfing, rather than being presentation of an ongoing streaming program. Further, the computing system 130 may find, from the query signature data and/or from the streaming-meter reported data, that such a short-lived program segment occurred interstitially between times when the panelist site 100 was not receiving and presenting any streaming media content, which may also suggest the occurrence of surfing activity. Still further, the computing system 130 may find, from the query signature data and/or from the streaming-meter reported data, that the panelist site 100 was receiving and presenting a continuous or intermittent sequence of such short segments of multiple different programs, e.g., changing from a preview of one program to a preview of another, etc., which may likewise suggest the occurrence of surfing activity. These and/or other such findings may thus help to support the computing system 130's finding and recording that there was surfing activity at the panelist site 100 at that time.

In addition, in connection with detecting a pattern of packet-data traffic consistent with surfing activity and/or detecting presentation of program-preview content, the computing system 130 may take into account one or more domain-specific events at the panelist site 100. For instance, if the streaming meter 108 reports (e.g., based on detected DNS queries and/or packet headers) that the panelist site 100 was engaged in communication with one or more particular domains at a particular time (e.g., communication with one or more domains of or related to particular streaming-media providers), the computing system 130 may correlate the occurrence of that domain-specific communication with other information to help support a finding that surfing activity occurred at the panelist site 100 at that time.

By way of example, the computing system 130 may correlate such domain-specific communication with one or more packet-data-traffic events detected at that time (e.g., messaging activity), as a further basis to support a finding of surfing activity. For instance, the computing system 130 may find that the panelist site 100 engaged in a pattern of control messaging specifically with a streaming-media provider that would be suggestive of progressive downloading of content-selection menus or menu items and thus would suggest the occurrence of surfing activity. As another example, the computing system 130 may correlate such domain-specific communication with one or more detected short segments of streaming content, as a further basis to support a finding of surfing activity. For instance, the computing system 130, may find that the one or more detected short segments of streaming content came from a streaming-media provider as well and were interspersed with other control signaling with that streaming-media provider, thus suggesting surfing as to that streaming-media provider.

As noted above, to facilitate detecting the occurrence of surfing activity based at least on (i) detecting a pattern of packet-data traffic consistent with surfing activity and/or (ii) detecting presentation of program-preview content, the computing system 130 may refer to pre-established surfing-profile data 136 that indicates characteristics of surfing activity perhaps specifically on a per-streaming-media-provider basis. Further, the presentation meter 106 and/or streaming meter 108 may be configured to report information (e.g., query signature data and packet-data-traffic events) that the computing system 130 could correlate with that surfing-profile data 136 as a basis for the computing system 130 to determine when surfing activity was occurring at a panelist site 100, perhaps specifically to determine when surfing activity particular to a given streaming-media provider was occurring at the panelist site 100. Thus, given the information reported from the one or more meters, the computing system 130 may refer to the surfing-profile data 136 to determine that there was packet-data activity and/or interspersed streaming content characteristic of surfing activity possibly specific to a given streaming-media provider, and the computing system 130 may record associated media-exposure data.

To establish surfing-profile data 136 keyed at least in part to one or more patterns of packet-data traffic, the audience-measurement company could monitor packet-data traffic known to be of surfing activity as to each of various streaming-media providers and, based on that monitoring, could identify in that packet-data traffic various traffic patterns that are characteristic of the surfing activity. In particular, the audience-measurement company could look for traffic patterns that seem to be typical of the surfing activity and that seem to be atypical of other (non-surfing) activity. For instance, the audience-measurement company could compare packet-data traffic of known surfing activity with packet-data traffic of known non-surfing activity, and based on that comparison, could identify traffic patterns that tend to occur in the surfing packet-data traffic and that tend to not occur in the non-surfing packet-data traffic.

As noted above, examples of these traffic patterns may include, without limitation (i) particular rates or other timing patterns of control messaging to/from a media-presentation device such as a streaming-media player, possibly when such messaging is with a particular streaming-media provider or the like, and possibly when the messaging is characteristic of progressive downloading of content-selection menus or menu items (e.g., content thumbnails) or the like and (ii) particular sizes of such control messages to/from the media-presentation device, possibly in conjunction with the rates or other timing patterns. Further, if a streaming-media provider streams or otherwise presents program previews when a user is surfing through the streaming-media provider's content-selection menus, examples of these traffic packet-data-traffic patterns may also include associated timing of streaming media traffic, such as interstitial short segments of streaming activity also possibly coming from the streaming-media provider in particular, and possibly associated bit rates of the program-preview streaming-media traffic, which may characteristically differ from streaming of actual programs.

In addition, to establish surfing-profile data keyed at least in part to one or more patterns of program-preview streaming and/or program-preview presentation, the audience-measurement company could monitor the timing of preview-content-segment presentation during known surfing activity as to each of various streaming-media providers and, based on that monitoring, could identify timing and/or other characteristic patterns related to that presentation. For instance, based on matching of query signature data to reference signature data, the audience-measurement company could determine that, when a user surfs through content-selection menus of a given streaming-media provider, program-preview snippets of a particular duration get presented. Moreover, the audience-measurement company could correlate the timing of this program-preview presentation with identified packet-data-traffic patterns during the known surfing activity, to establish composite pattern data characteristic of surfing activity.

The surfing-profile data 136 may define one or more patterns of packet-data traffic characteristic of surfing activity so as to help distinguish from various instances of packet-data traffic that are not characteristic of surfing activity. For instance, the surfing-profile data 136 may define patterns of packet-data activity that are characteristic surfing activity and are not characteristic of activities such as (i) a user merely switching form one streaming-media provider to another, unless that is deemed to be surfing, (ii) background updating of a media player or other panelist-site device, among other possibilities.

The audience-measurement company could engage in this process to build the surfing-profile data 136 in various ways. By way of example, the audience-measurement company could set up a lab and have users in the lab intentionally surf through content-selection menus respectively provided by each of various streaming media providers, and the audience-measurement company could implement meters and other monitoring systems to facilitate identifying characteristic surfing patterns.

For instance, streaming meters or other computing devices in the lab could be set to detect and report associated packet-data-traffic events such as (i) when messaging with a streaming-media provider occurs, (ii) domain-specific events including communications being with particular streaming-media providers and/or others that may supply content-selection menu or menu items, (iii) when there is traffic with high enough bit rate to suggest possible streaming such as program-preview streaming, and so forth.

In particular, the audience-measurement company may configure one or more such streaming meters in the lab to monitor for and report packet-data-traffic events that would help facilitate determining when packet-data traffic at the panelist site 100 had a pattern of surfing possibly specific to a particular streaming media provider. For instance, the audience-measurement company may configure each such streaming meter to detect and report domain-specific events such as messaging between the panelist site 100 and a streaming-media provider, as well as interstitial high-bit-rate events, among other possibilities.

Furthermore, to help account for program-preview presentation during surfing, one or more presentation meters in the lab could be set to monitor presentation, extract or generate query signature data, and report the query signature data to facilitate identification of the presented content, and a computing system 130 as noted above could match the query signature data with SMMS reference-signature data 134 to identify the presented content and to determine the timing of those presentations such as duration of each preview, among other possibilities, which may also be specific to particular streaming-media providers.

As another example, the audience-measurement company may arrange with actual panelists to inform the audience-measurement company, e.g., through manual entry into presentation meters or the like, when the panelists are engaged in surfing activity, also possibly with respect to particular streaming-media providers. The audience-measurement company may then correlate those indicated times with streaming-meter-reported packet-data-traffic events associated with the panelists and with presentation-meter-reported query signature data associated with the panelists to facilitate evaluation.

Engineers or automated computing processes could then review these packet-data-traffic events and possible timing of program-preview presentations as a basis to identify patterns, such as by finding recurrences of certain packet-data-traffic activity timing or the like and/or recurrences of program-preview presentation timing or the like, which may alone or in combination with each other be characteristic of, and thus suggestive of, surfing activity, possibly on a per-streaming-media-provider basis. The audience-measurement company may then establish data records of these identified patterns in a manner that the computing system 130 could then use at run time to detect surfing activity as noted above.

Note also that machine-learning could be used as a basis to identify patterns of packet-data-traffic and/or content presentation that are characteristic of surfing activity possibly on a per-streaming-media-provider basis. For instance, the audience-measurement company could train a machine-learning model with input data regarding packet-data-traffic events and content presentation labeled to distinguish known surfing activity from known non-surfing activity, and possibly to distinguish surfing activity as to each streaming-media provider from surfing activity as to each other streaming-media provider, so that the machine-learning model could learn to classify surfing activity versus non-surfing activity and possibly to distinguish surfing activity on a per-streaming-media-provider basis. The audience-measurement company could use any of various machine-learning models for this purpose, such as neural-network models (e.g., convolutional neural networks), decision-tree models, and others, whether supervised or unsupervised.

This training of a machine-learning model may require a sufficiently large set of data samples. The audience-measurement company may obtain those data samples by using a large population of actual panelists to monitor known surfing activity versus known non-surfing activity, and possibly on a per-streaming-media-provider basis, over a sufficiently long period of time for instance. The resulting trained machine-learning model may then effectively be the surfing-profile data, or at least party of the surfing-profile data, that the computing system 130 could use as a basis to detect the occurrence of surfing activity, possibly on a per-streaming-media-provider basis, at run time.

To facilitate use of the established surfing-profile data in practice as a basis to detect the occurrence of surfing activity, possibly on a streaming-media-provider basis, at each of various panelist site 100s or the like, the audience-measurement company may further configure a streaming meter at each panelist site 100 to detect and report packet-data-traffic events, including domain-specific events, that would help enable the computing system 130 to detect when packet-data traffic at the panelist site 100 had a pattern of surfing possibly specific to a particular streaming media provider. Further, the audience-measurement company may configure the streaming meter to perform this monitoring specifically with respect to one or more media-presentation devices on the panelist site 100 LAN that may be involved with such surfing activity, such as one or more streaming-media players for instance.

Based on meter-reported data as to the panelist site 100, the computing system 130 may then detect when surfing activity, possibly specific to a given streaming-media provider, occurred at the panelist site 100. For instance, as to a given time segment that the computing system 130 evaluates, the computing system 130 may first determine that query signature data representing content presented during that time segment does not match any of the LMMS reference-signature data 132. In response to that determination, the computing system 130 may then determine that packet-data-activity at the panelist site 100 in that time segment did not have a pattern of streaming. Further, in response to that determination, or even without one or more of these determinations, the computing system 130 may evaluate to determine if there was surfing activity at the panelist site 100 in that time segment and possibly to determine the streaming-media provider (e.g., streaming-media channel) through whose content-selection menu or menus a user was surfing at the time.

To determine if there was surfing activity at the panelist site 100 in that time segment, for instance, the computing system 130 may refer to the surfing-profile data to determine whether meter-reported data represents or suggests the occurrence of characteristic surfing activity in that time period. And if so, the computing system 130 may record media-exposure data indicating the occurrence of surfing activity at the panelist site 100 in that time period, possibly in correlation with panelist demographic data, rather than reporting an inconclusive result for that time period.

Moreover, based on this analysis, the computing system 130 could determine which of various streaming-media providers was the subject of the detected surfing activity, namely, through which streaming-media provider's (e.g., which stream-media channel's) content-selection menu or menus a user at the panelist site 100 was surfing at the time. In particular, by reference to surfing-profile data that distinguishes between surfing activity as to various streaming-media providers, the computing system 130 may find that the meter-reported data as to the time segment at issue was characteristic of surfing through one or more content-selection menus of a particular streaming-media provider.

Upon detecting the occurrence of surfing activity in that time period, the computing system 130 then usefully record the fact of that occurrence as media-exposure data, e.g., crediting the surfing activity as having occurred at the panelist site 100 at that time—rather than merely recording an inconclusive result for that time period.

Note also that the computing system 130's detection of surfing activity at a panelist site 100, possibly with respect to a given streaming-media provider, could additionally be based on one or more other factors as well.

For instance, the computing system 130 may also take into account subscription data for the panelist site 100, such as pre-provisioned panelist-site profile data to determine that the panelist site 100 subscribes to service of one or more particular streaming-media providers, as a basis to confirm detecting of surfing activity with respect to a given one of those streaming-media providers.

Further, the computing system 130 may also take into account remote control input, such as remote control commands that would direct navigation through a streaming-media provider's content selection menus. Consideration of this information may be possible if a meter at the panelist site 100 is integrated with a device that would receive to such remote control commands, such as if a meter is integrated with a streaming-media player or the like at the panelist site 100, and if the meter has a view of remote control commands received by that device. Such a meter may then detect remote control commands (such as navigation up, down, left, or right, etc.) and may report to the computing system 130 the occurrence of those commands. Further, the surfing-profile data could be enhanced to include patterns of such remote control commands that may be characteristic of surfing activity. The computing system 130 may take into consideration the timing of remote control commands at run time, possibly in relation to packet-data-traffic and/or signature matching data, as a further basis to detect characteristic surfing activity at the panelist site 100.

### Example Process Flow

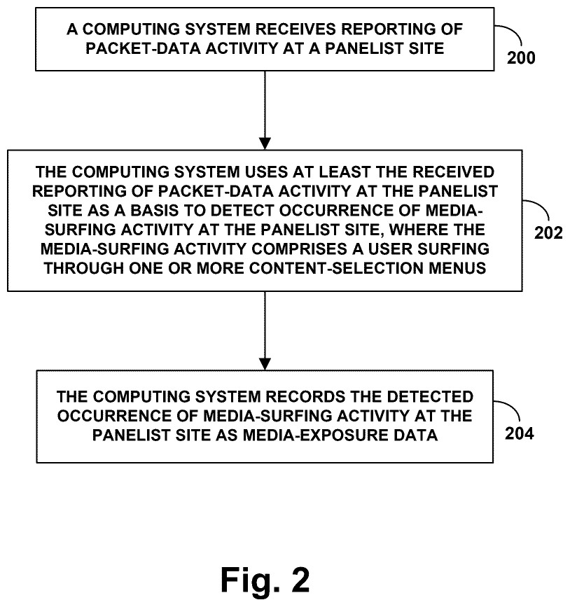

FIG. 2 is a flow chart illustrating a method that could be carried out in accordance with the present disclosure for measuring media-surfing activity (e.g., for detecting and recording occurrence of the surfing, possibly specific as to a given streaming-media provider).

As shown in FIG. 2, at block 200, the method includes a computing system receiving reporting of packet-data activity at a panelist site. At block 202, the method then involves the computing system using at least the received reporting of packet-data activity at the panelist site as a basis to detect occurrence of media-surfing activity at the panelist site, where the media-surfing activity comprises a user surfing through one or more content-selection menus. Further, at block 204, the method includes the computing system recording the detected occurrence of media-surfing activity at the panelist site as media-exposure data.

In line with the discussion above, the act of receiving the reporting of packet-data activity at the panelist could involve receiving the reporting from a streaming meter operating at the panelist site.

Further, the act of using at least the received reporting of packet-data activity at the panelist site as a basis to detect occurrence of media-surfing activity at the panelist site could involve determining that the packet-data activity defines a pattern that is characteristic of media-surfing activity. And the act of determining that the packet-data activity defines a pattern that is characteristic of media-surfing activity could involve referring to pre-established surfing-profile data that indicates one or more patterns of packet-data activity that are characteristic of surfing activity, as a basis to determine that the reported packet-data activity defines at least one of the one or more patterns of packet-data activity.

Still further, the act of using at least the received reporting of packet-data activity at the panelist site as a basis to detect occurrence of media-surfing activity at the panelist site could involve determining that the packet-data activity defines a pattern that is characteristic of media-surfing activity as to a particular streaming-media provider, and the recording of the detected occurrence of media-surfing activity at the panelist site as media-exposure data could involve recording the detected occurrence of media-surfing activity as to the particular streaming-media provider as media-exposure data. And here, the act of determining that the packet-data activity defines a pattern that is characteristic of media-surfing activity as to the particular streaming media provider could involve referring to pre-established surfing-profile data that indicates, separately for each of a plurality of streaming-media providers, one or more patterns of packet-data activity each characteristic of surfing activity as to the streaming-media provider, as a basis to determine that the reported packet-data activity defines at least one of the one or more patterns of packet-data activity as to the particular streaming-media provider.

Yet further, the act of determining that the packet-data activity defines a pattern that is characteristic of media-surfing activity could involve determining, based at least on timing of message communication with a streaming-media provider, that the packet-data activity defines a pattern that is characteristic of media-surfing activity.

Moreover, the act of determining that the packet-data activity defines a pattern that is characteristic of media-surfing activity could involve determining, based at least on duration of streaming media transmission to the panelist site, that the packet-data activity defines a pattern that is characteristic of media-surfing activity. And the act of based at least on the duration of streaming media transmission to the panelist site that the packet-data activity defines a pattern that is characteristic of media-surfing activity could involve determining that the duration of streaming media transmission to the panelist site is characteristic of program-preview streaming rather than full program streaming.

In addition, the method could involve the computing system receiving query signature data representing media content presented at the panelist site and the computing system matching the digital query signature data with digital reference signature data, as a basis to identify streaming-media content presented at the panelist site. And the act of the computing system using at least the received reporting of packet-data activity at the panelist site as a basis to detect occurrence of media-surfing activity at the panelist site could involve the computing system using at least the received reporting of packet-data activity and the matching of the digital query signature data with the digital reference signature data, as a basis detect occurrence of media-surfing activity at the panelist site.

Further, the act of the computing system using the matching of the digital query signature data with the digital reference signature data as a basis to detect occurrence of the media-surfing activity at the panelist site could involve the computing system finding, based on the matching, presentation of program content at the panelist site for just a program-preview duration.

### Example Computing System and Meters

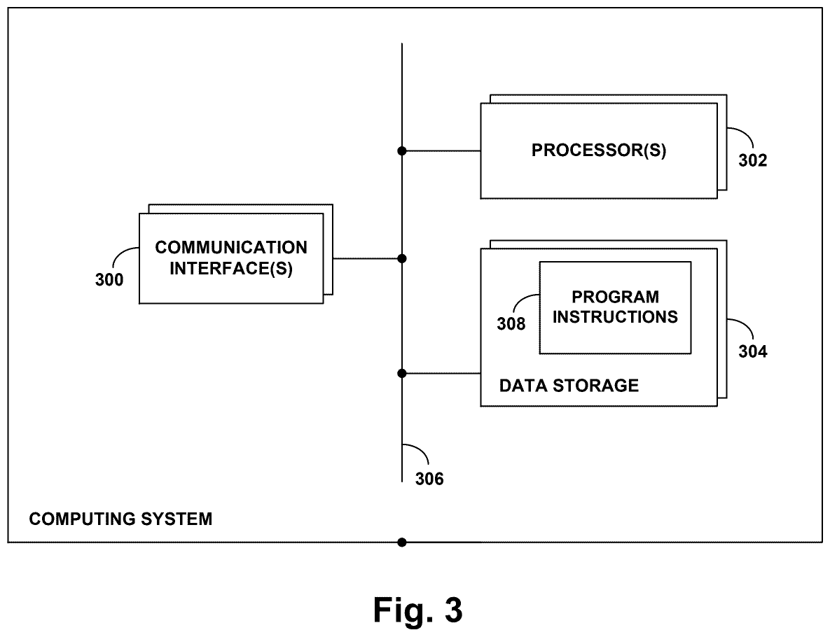

FIG. 3 is a simplified block diagram of a computing system that could be configured to carry out various operations such as those discussed herein. This computing system may represent one or more aspects of the computing system 130 discussed above.

As shown in FIG. 3, the example computing system could include at least one communication interface 300, at least one processor 302, and at least one non-transitory data storage 304, which could integrated together or communicatively linked together by a system bus, network, or one or more other connection mechanisms 306.

The at least one communication interface 300 could comprise one or more interfaces to facilitate wired and/or wireless communication with one or more other entities. Examples of such interfaces could include, without limitation, wired Ethernet interfaces and/or WiFi interfaces.

The at least one processor 302 could comprise one or more general purpose processing units (e.g., microprocessors) and/or one or more specialized processing units (e.g., digital signal processors (DSPs), graphics processing units (GPUs), neural processing units (NPUs), etc.) Further, the at least one non-transitory data storage 304 could comprise one or more volatile and/or non-volatile storage components (e.g., flash, optical, magnetic, ROM, RAM, EPROM, EEPROM, etc.), which may be integrated in whole or in part with the at least one processor 302. As further shown, the at least one non-transitory data storage 304 could store program instructions 308, which may be executable by the at least one processor 302 to carry out various computing-system operations described herein, such as those described above with respect to FIG. 2 for instance. Further, a computing system like this could also implement functions such as those discussed above to establish the surfing-profile data.

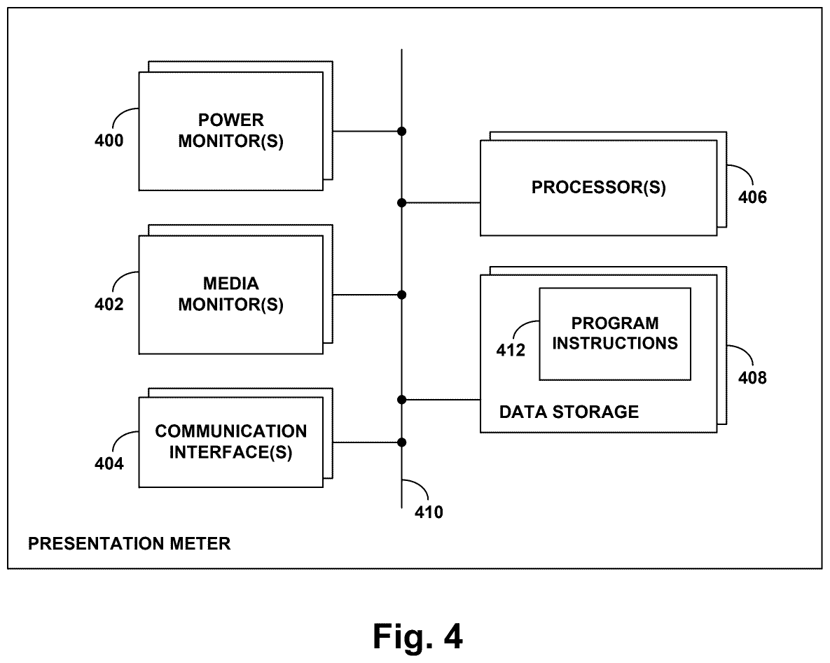

FIG. 4 is a simplified block diagram of a presentation meter. As noted above, such a presentation meter could be positioned and/or connected in a manner that enables the presentation meter to monitor media presented by a media-presentation device such as device 104, and that may also enable the presentation meter to monitor the on/off status of the media-presentation device.

As shown in FIG. 4, the example presentation meter includes at least one power monitor 400, at least one media monitor 402, at least one communication interface 404, at least one processor 406, and at least one non-transitory data storage 408, which could integrated together or communicatively linked together by a system bus, network, or one or more other connection mechanisms 410.

The at least one power monitor 400 could comprise a circuit for monitoring power flow to the media-presentation device, such as by tapping into a power-supply path to the media-presentation device and measuring current flow. The at least one power monitor 400 may thus operate to determine when the media-presentation device is powered on and when the media-presentation device is powered off.

The at least one media monitor 402 may comprise one or more microphones and/or cameras and associated processing circuitry or other logic configured to monitor media output from the media-presentation device and/or a circuit for monitoring media flow into the media-presentation device by tapping into a media-delivery path to the media-presentation device. The at least one media monitor 402 may thus operate to detect media presentation by the media-presentation device, which may further include obtaining media-signature data to facilitate identifying the presented media.

The at least one communication interface 404 may comprise one or more wired and/or wireless network interfaces, such as wired Ethernet interfaces and/or WiFi interfaces, to facilitate communication with other entities. For instance, the illustrated meter may use such a communication interface to report logged information to another meter and/or to an audience-measurement server, among other possibilities.

The at least one processor 406 may comprise one or more general purpose processing units (e.g., microprocessors) and/or one or more specialized processing units (e.g., DSPs, GPUs, NPUs, etc.) Further, the at least one non-transitory data storage 408 may comprise one or more volatile and/or non-volatile storage components (e.g., flash, optical, magnetic, ROM, RAM, EPROM, EEPROM, etc.), which may be integrated in whole or in part with the at least one processor 406. Still further, the at least one non-transitory data storage 408 may store program instructions 412, which may be executable by the at least one processor 406 to carry out various operations described herein.

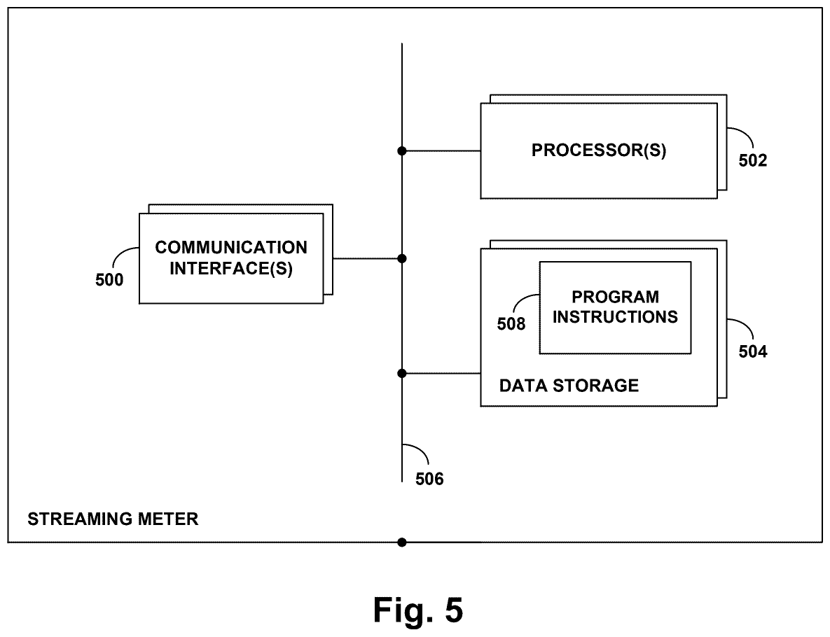

FIG. 5 is a simplified block diagram of a streaming meter. As noted above, such a streaming meter could be provided in a manner that enables the streaming meter to monitor packet flow on a LAN at a panelist site, so as to detect packet-data flow related to streaming media transmission.

As shown in FIG. 5, the example streaming meter includes at least one communication interface 500, at least one processor 502, and at least one non-transitory data storage 504, which could integrated together or communicatively linked together by a system bus, network, or one or more other connection mechanisms 506.

The at least one communication interface 500 may comprise one or more wired and/or wireless network interfaces, such as wired Ethernet interfaces and/or WiFi interfaces, to facilitate communication with other entities. For instance, the illustrated meter may use such a communication interface to engage in packet-sniffing on the LAN so as to detect on the LAN packet traffic related to streaming-media transmission. Further, the meter may use such a communication interface to report logged information to another meter and/or to a computing system, among other possibilities.

The at least one processor 502 may comprise one or more general purpose processing units (e.g., microprocessors) and/or one or more specialized processing units (e.g., DSPs, GPUs, NPUs, etc.) Further, the at least one non-transitory data storage 504 may comprise one or more volatile and/or non-volatile storage components (e.g., flash, optical, magnetic, ROM, RAM, EPROM, EEPROM, etc.), which may be integrated in whole or in part with the at least one processor 502. Still further, the at least one non-transitory data storage 504 may store program instructions 508, which may be executable by the at least one processor 502 to carry out various operations described herein.

The present disclosure also contemplates at least one non-transitory computer readable medium that is encoded with, stores, or otherwise embodies program instructions executable by at least one processor to carry out various operations as described above.

Exemplary embodiments have been described above. Those skilled in the art will understand, however, that changes and modifications may be made to these embodiments without departing from the true scope and spirit of the invention.

We claim:

1. A method for measuring media-surfing activity, the method comprising:
receiving, by a computing system, reporting of packet-data activity at a panelist site;
using, by the computing system, at least the received reporting of packet-data activity at the panelist site as a basis to detect occurrence of media-surfing activity at the panelist site, wherein the media-surfing activity comprises a user surfing through one or more content-selection menus; and
recording, by the computing system, the detected occurrence of media-surfing activity at the panelist site as media-exposure data.

2. The method of claim 1, wherein receiving the reporting of packet-data activity at the panelist comprises receiving the reporting from a streaming meter operating at the panelist site.

3. The method of claim 1, wherein using at least the received reporting of packet-data activity at the panelist site as a basis to detect occurrence of media-surfing activity at the panelist site comprises:
determining that the packet-data activity defines a pattern that is characteristic of media-surfing activity.

4. The method of claim 3, wherein determining that the packet-data activity defines a pattern that is characteristic of media-surfing activity comprises:
referring to pre-established surfing-profile data that indicates one or more patterns of packet-data activity that are characteristic of surfing activity, as a basis to determine that the reported packet-data activity defines at least one of the one or more patterns of packet-data activity.

5. The method of claim 1, wherein using at least the received reporting of packet-data activity at the panelist site as a basis to detect occurrence of media-surfing activity at the panelist site comprises:
determining that the packet-data activity defines a pattern that is characteristic of media-surfing activity as to a particular streaming-media provider,
wherein recording the detected occurrence of media-surfing activity at the panelist site as media-exposure data comprises recording the detected occurrence of media-surfing activity as to the particular streaming-media provider as media-exposure data.

6. The method of claim 5, wherein determining that the packet-data activity defines a pattern that is characteristic of media-surfing activity as to the particular streaming media provider comprises:
referring to pre-established surfing-profile data that indicates, separately for each of a plurality of streaming-media providers, one or more patterns of packet-data activity each characteristic of surfing activity as to the streaming-media provider, as a basis to determine that the reported packet-data activity defines at least one of the one or more patterns of packet-data activity as to the particular streaming-media provider.

7. The method of claim 1, wherein determining that the packet-data activity defines a pattern that is characteristic of media-surfing activity comprises:
determining, based at least on timing of message communication with a streaming-media provider, that the packet-data activity defines a pattern that is characteristic of media-surfing activity.

8. The method of claim 1, wherein determining that the packet-data activity defines a pattern that is characteristic of media-surfing activity comprises:
determining, based at least on duration of streaming media transmission to the panelist site, that the packet-data activity defines a pattern that is characteristic of media-surfing activity.

9. The method of claim 8, wherein determining based at least on the duration of streaming media transmission to the panelist site that the packet-data activity defines a pattern that is characteristic of media-surfing activity comprises determining that the duration of streaming media transmission to the panelist site is characteristic of program-preview streaming rather than full program streaming.

10. The method of claim 1, further comprising:
receiving, by the computing system, query signature data representing media content presented at the panelist site; and
matching, by the computing system, the digital query signature data with digital reference signature data, as a basis to identify streaming-media content presented at the panelist site, wherein using, by the computing system, at least the received reporting of packet-data activity at the panelist site as a basis to detect occurrence of media-surfing activity at the panelist site comprises using, by the computing system, at least the received reporting of packet-data activity and the matching of the digital query signature data with the digital reference signature data, as a basis detect occurrence of media-surfing activity at the panelist site.

11. The method of claim 10, wherein using by the computing system the matching of the digital query signature data with the digital reference signature data as a basis to detect occurrence of the media-surfing activity at the panelist site comprises finding by the computing system, based on the matching, presentation of program content at the panelist site for just a program-preview duration.

12. A computing system comprising:
at least one processor;
at least one non-transitory data storage;
program instructions stored in the at least one non-transitory data storage and executable by the at least one processor to carry out operations for measuring media-surfing activity, the operations including:
receiving reporting of packet-data activity at a panelist site,
using at least the received reporting of packet-data activity at the panelist site as a basis to detect occurrence of media-surfing activity at the panelist site, wherein the media-surfing activity comprises a user surfing through one or more content-selection menus, and
recording the detected occurrence of media-surfing activity at the panelist site as media-exposure data.

13. The computing system of claim 12, wherein receiving the reporting of packet-data activity at the panelist comprises receiving the reporting from a streaming meter operating at the panelist site.

14. The computing system of claim 12, wherein using at least the received reporting of packet-data activity at the panelist site as a basis to detect occurrence of media-surfing activity at the panelist site comprises:
determining that the packet-data activity defines a pattern that is characteristic of media-surfing activity as to a particular streaming-media provider,
wherein recording the detected occurrence of media-surfing activity at the panelist site as media-exposure data comprises recording the detected occurrence of media-surfing activity as to the particular streaming-media provider as media-exposure data.

15. The computing system of claim 14, wherein determining that the packet-data activity defines a pattern that is characteristic of media-surfing activity as to the particular streaming media provider comprises:
referring to pre-established surfing-profile data that indicates, separately for each of a plurality of streaming-media providers, one or more patterns of packet-data activity each characteristic of surfing activity as to the streaming-media provider, as a basis to determine that the reported packet-data activity defines at least one of the one or more patterns of packet-data activity as to the particular streaming-media provider.

16. The computing system of claim 12, wherein determining that the packet-data activity defines a pattern that is characteristic of media-surfing activity comprises:
determining, based at least on timing of message communication with a streaming-media provider, that the packet-data activity defines a pattern that is characteristic of media-surfing activity.

17. The computing system of claim 12, wherein the operations additionally include:
receiving query signature data representing media content presented at the panelist site; and
matching the digital query signature data with digital reference signature data, as a basis to identify streaming-media content presented at the panelist site,
wherein using at least the received reporting of packet-data activity at the panelist site as a basis to detect occurrence of media-surfing activity at the panelist site comprises using, by the computing system, at least the received reporting of packet-data activity and the matching of the digital query signature data with the digital reference signature data, as a basis detect occurrence of media-surfing activity at the panelist site.

18. The method of claim 10, wherein using by the computing system the matching of the digital query signature data with the digital reference signature data as a basis to detect occurrence of the media-surfing activity at the panelist site comprises finding by, based on the matching, presentation of program content at the panelist site for just a program-preview duration.

19. At least one non-transitory computer-readable medium having stored thereon instructions executable by at least one processor to cause a computing system to carry out operations for measuring media-surfing activity, the operations comprising:
receiving reporting of packet-data activity at a panelist site;
using at least the received reporting of packet-data activity at the panelist site as a basis to detect occurrence of media-surfing activity at the panelist site, wherein the media-surfing activity comprises a user surfing through one or more content-selection menus; and
recording the detected occurrence of media-surfing activity at the panelist site as media-exposure data.

20. The at least one non-transitory computer-readable medium of claim 19, wherein the operations further comprise:
receiving query signature data representing media content presented at the panelist site; and
matching the digital query signature data with digital reference signature data, as a basis to identify streaming-media content presented at the panelist site,
wherein using at least the received reporting of packet-data activity at the panelist site as a basis to detect occurrence of media-surfing activity at the panelist site comprises using, by the computing system, at least the received reporting of packet-data activity and the matching of the digital query signature data with the digital reference signature data, as a basis detect occurrence of media-surfing activity at the panelist site.
